(19) United States
(12) Patent Application Publication
(10) Pub. No.: US 2003/0019903 A1
(43) Pub. Date: Jan. 30, 2003

(54) Jaw structure for staple guns

(76) Inventor: Chi-Tien Lin, Taichung (TW)

Correspondence Address: BACON & THOMAS, PLLC, 625 Slaters Lane - 4th Floor, Alexandria, VA, 22314-1176, US

(21) Appl. No.: 09/916,333

(22) Filed: Jul. 30, 2001

(51) Int. Cl. B25C 5/02

(52) U.S. Cl. 227/123; 227/127

(57) ABSTRACT

An improved jaw structure for staple guns that may be disassembled easily from the gun barrel consists of a lower plate pivotally mounting to the barrel of the staple gun and having two retain hooks located thereon, and a slide block movable between the retain hooks having a rear end engaged with a spring. The slide block may be disengaged from the retain hooks by users' pushing, and may engage automatically with the retain hooks by the restoring force of the spring thereby to fasten the lower plate to an upper plate of the staple gun.

### BACKGROUND OF THE INVENTION

The present invention relates to an improved jaw structure for staple guns and particularly a jaw that is simply structured and includes retain hooks, a slide block and a spring for easy operation and saving time.

Demands for high quality staple guns have been growing constantly. To make the staple guns easy to repair and maintain is one of the main design considerations. Although there are a wide variety of pneumatic staple guns available on the market these days, it happens that the staple guns are prone to jam occasionally. Hence it is essential to make the jaw structure of the staple guns easy to disassemble. Easy operation and simple in repairs and maintenance have become key concerns of consumers. Therefore they also are the issues which staple gun producers have invested a lot of research and development efforts. The present invention aims at providing an improved jaw structure for such purpose.

Conventional jaw structure for staple guns, such as the one shown in FIG. 1, usually includes an upper plate 11 pivotally mounting to the gun barrel 10 and having two pivotal juts 12 and a hook frame 13 located thereon. The pivotal juts 12 engage with a buckle cap 14 which has a buckle hook 15 engageable with the buckle frame 13. The buckle cap 14 may be pressed downwards to fasten the buckle hook 15 securely to the hook frame 13, or be flipped upwards to disengage the buckle hook 15 from the hook frame 13. Such a design still has functional deficiency and is not convenient to operate or effective, as many operation steps are involved, notably:

1. To flip the upper plate 11 upwards to do the repairs and maintenance of the guns, the buckle cap 14 must be turned about the pivotal juts 12 to disengage the buckle hook 15 from the hook frame 13. Multiple parts and operations are required.

2. The constructions of the conventional staple guns always require two-step operations to fasten or open the jaw. At working sites, workers have to spend more time using one hand to disassemble the jaw of the staple guns, it increases total working processes and duration.

Moreover, to improve the smooth operations of the opening of the buckle cap 14 is also a prevailing trend nowadays. Conventional designs and structures still have rooms for improvements.

### SUMMARY OF THE INVENTION

In view of aforesaid disadvantages, it is therefore a primary object of the invention is to provide an improved jaw structure for staple guns that is simpler to operate. The jaw structure of the invention includes an upper plate pivotally engaged with the gun barrel, and a lower plate having two retain hooks to couple with a slide block located on the upper plate. The slide block may be moved linearly on the upper plate to allow the upper plate engaging or disengaging with the retain hooks thereby to disassemble the jaw simply and easily.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional jaw for staple guns.

FIG. 2 is an exploded view of the invention.

FIG. 3 is a schematic view of the invention at an open state.

FIG. 4 is a fragmentary side view of the invention, at a fastening state.

FIG. 5 is a schematic top view of the invention, at a fastening state.

FIG. 6 is a fragmentary side view of the invention, at a disengaging state.

FIG. 7 is a schematic top view of the invention, at a disengaging state.

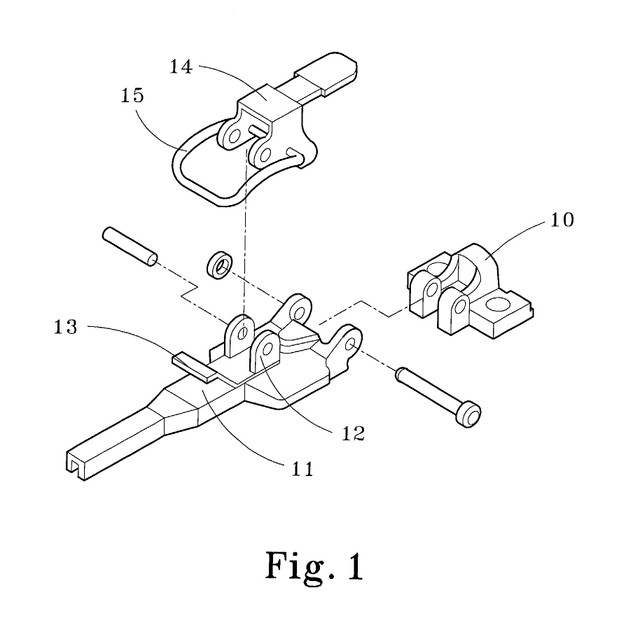

### DESCRIPTION OF THE PREFERRED EMBODIMENT

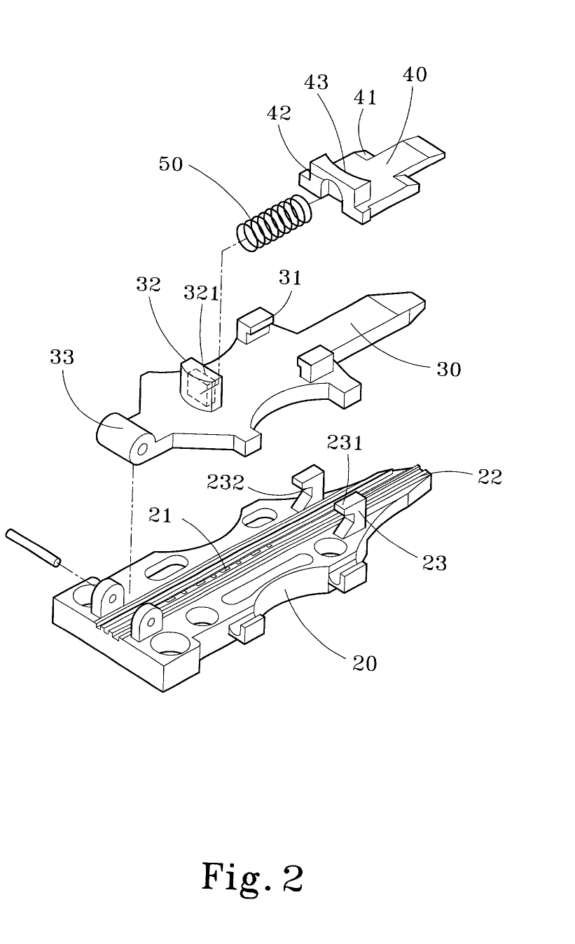

Referring to FIG. 2 for an embodiment of the invention, the jaw structure consists of a lower plate 20, an upper plate 30, a slide block 40 and a spring 50.

The lower plate 20 is mounted to the barrel 10 of a staple gun, and has staple apertures 21 and staple grooves 22 located in the center thereof, and two retain hooks 23 located at two sides of the staple grooves 22 opposing to each other. Each of the retain hooks 23 is substantially formed in L-shape with a jut end 231 and an indented sloped surface 232 below the jut end 231.

The upper plate 30 has a pivotal section 33 located at one end for pivotally engaging with the lower plate 20 and may be lain on the lower plate 20 bypassing the retain hooks 23. The upper plate 30 further has two guide stubs 31 matching the retain hooks 23. Each guide stub 31 is substantially formed in L-shape. There is an anchor seat 32 spaced from the guide stubs 31. The anchor seat 32 has a cavity 321 formed therein facing the guide stubs 31.

The slide block 40 is movable linearly between the guide stubs 31 and has a slant edge 41 formed at one end matching the indented sloped surface 232 of the retain hooks 23, and a trigger block 43 formed thereon which has a harbor seat 42 corresponding to the anchor seat 32 of the upper plate 30.

The spring 50 is an elastic element and has one end held in the cavity 321 of the anchor seat 32 and another end held in the harbor seat 42 of the slide block 40.

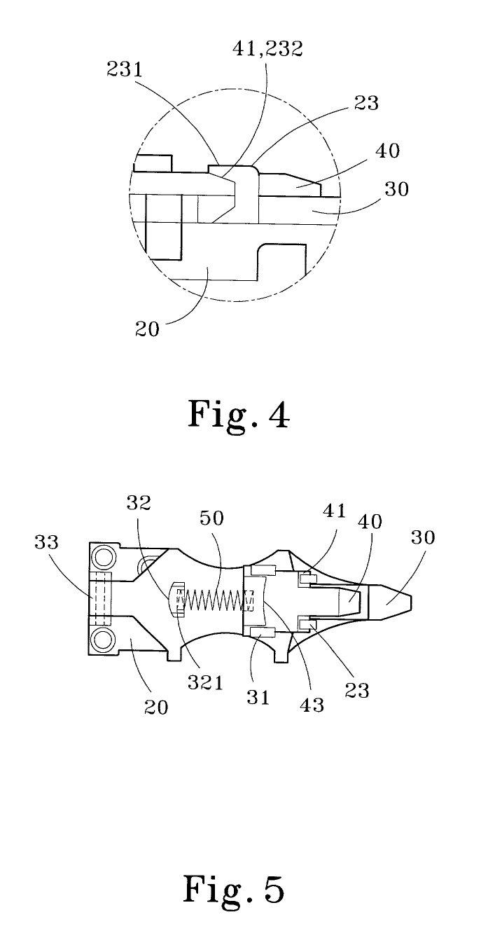

Referring to FIGS. 4 and 5, when the jaw is under fastening, the upper plate 30 is resting on the lower plate 20 with the slide block 40 wedging and harnessing between the guide stubs 31. The slide block 40 is pushed by the spring 50 at the harbor seat 42 such that the slant edge 41 will wedge in the indented sloped surface 232 of the retain hooks 23 below the jut end 231. Hence the upper plate 30 will be engaged with the lower plate 20 securely through the slide block 40.

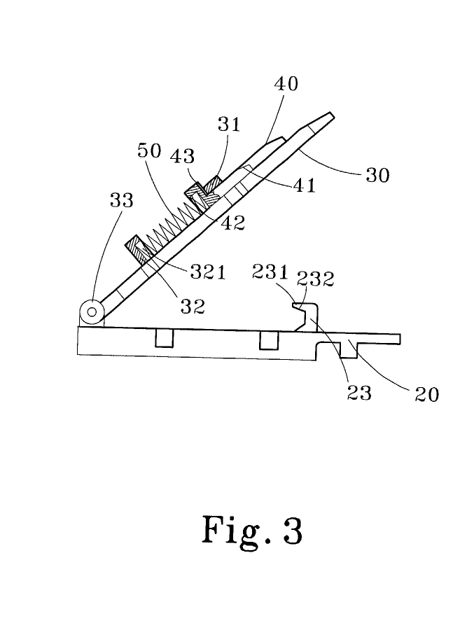

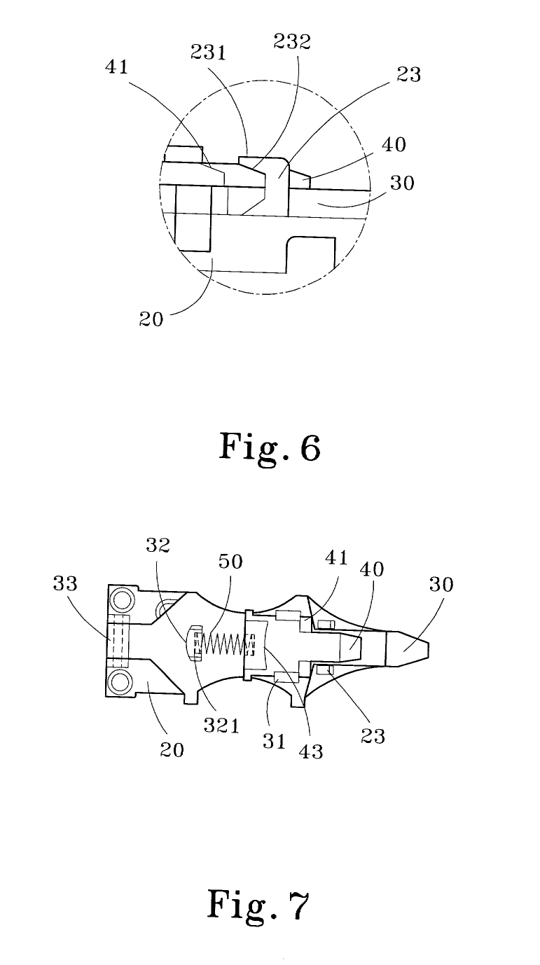

Referring to FIGS. 3, 6 and 7, when to disengage and open the upper plate 30, an user pushes the trigger block 43 of the slide block 40 with a finger against and compressing the spring 50 to move the slant edge 41 of the slide block 40 away from the indented sloped surface 232 of the retain hooks 23 until the slant edge 41 disengaging from the jut end 231. Then the upper plate 30 may be lifted from the lower plate 20 and opened easily. Hence simply using one finger to move the trigger block 43 of the slide block 40, the jaw may be fastened to or disengaged from the gun barrel easily and quickly with little effort.

It is to be noted that the retain hook 23 may also be formed in a [symbol] -shaped bracket while the upper plate 30 has an opening to bypass the [symbol] -shaped bracket, and the slide block 40 may has a jut front end matching the [symbol] -shaped bracket to achieve the wedging and engaging effect. Another embodiment is to form the guide stubs 31 in a turtledove tail shape and the slide block 40 formed in a matching turtledove tail shape to restrict the slide block 40 moving linearly within a selected boundary.

In summary, the invention has an upper plate pivotally engaged with the barrel of the staple gun, and a lower plate having two retain hooks. The upper plate has a slide block engageable with the retain hooks under the force of a spring located at the rear end of the slide block. The slide block may be pushed to disengage from the retain hooks, or be engaged with the retain hooks under the restoring force of the spring to keep the lower plate fastening to the upper plate of the jaw of the staple gun.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. An improved jaw structure for a staple gun, comprising:
a lower plate mounting to a barrel of the staple gun and having selected number of retain elements integrally formed thereon;
an upper plate located above the lower plate having one end pivotally engaged with the lower plate and an anchor seat and selected number of guide elements mounted thereon;
a slide block located on the upper plate between the anchor seat and the guide elements and being movable linearly between the guide elements to engage or disengage with the retain elements of the lower plate; and
an elastic element having one end engaged with the anchor seat of the upper plate and engaged with the slide block to provide elastic force for returning the slide block to an initial position.

2. The improved jaw structure for a staple gun of claim 1, wherein the retain elements are two L-shaped retain hooks each having a jut end and an indented sloped surface below the jut end for engaging with a slant edge formed at one end of the slide block.

3. The improved jaw structure for a staple gun of claim 1, wherein the guide elements are a plurality of L-shaped guide stubs in pairs opposing with each other for harnessing the slide block therebetween.

4. The improved jaw structure for a staple gun of claim 1, wherein the slide block has a harbor seat located thereon for engaging securely with the elastic element.

5. The improved jaw structure for a staple gun of claim 1, wherein the slide block has a trigger block located thereon to facilitate moving of the slide block.

6. The improved jaw structure for a staple gun of claim 1, wherein the guide elements are turtledove tail shaped stubs, and the slide block having turtledove tail shaped elements movable between the guide elements.

7. The improved jaw structure for a staple gun of claim 1, wherein each of the retain elements is a [symbol] -shaped bracket, the upper plate having an opening to bypass the [symbol] -shaped bracket, and the slide block having a jut end matching the [symbol] -shaped bracket for wedging and engaging with the retain element.

8. The improved jaw structure for a staple gun of claim 1, wherein the upper plate is pivotally mounted to the gun barrel.

9. The improved jaw structure for a staple gun of claim 1, wherein the elastic element is a spring.
